(19) United States
(12) Patent Application Publication
(10) Pub. No.: US 2008/0285496 A1
(43) Pub. Date: Nov. 20, 2008

(54) Data download in wireless network

(75) Inventors: Meir Fuchs, Modiin (IL); Noam Amram, Kibbutz Megiddo (IL)

Correspondence Address: ROBERT G. LEV, 4766 MICHIGAN BLVD., YOUNGSTOWN, OH, 44505, US

(73) Assignee: Bamboo MediaCasting Ltd., Kfar Saba (IL)

(21) Appl. No.: 12/152,296

(22) Filed: May 14, 2008

Related U.S. Application Data
(60) Provisional application No. 60/924,409, filed on May 14, 2007.

(51) Int. Cl. G08C 17/00; H04J 3/00

(52) U.S. Cl. 370/311; 370/345

(57) ABSTRACT

A wireless receiver device including a wireless network interface and a processor configured to manage reception of data files through the network interface. The processor additionally is configured to determine network or wireless receiver device conditions and to delay reception of blocks of a file, responsive to the determined conditions meeting specific requirements, although the determined conditions allow reception of a block without the delay.

### RELATED APPLICATIONS

This application claims the benefit under 119(e) of U.S. provisional patent application 60/924,409, filed May 14, 2007, the disclosure of which is incorporated herein by reference.

### FIELD OF THE INVENTION

The present invention relates generally to communication networks and particularly to methods of efficient dissemination of data.

### BACKGROUND OF THE INVENTION

Cellular phones can be used for receiving video clips and other data, in addition to their use for point to point telephone communication. The amount of data that can be transmitted to mobile stations depends on the network conditions (e.g., topology, load, channel conditions). Accordingly, attempts have been made to improve network conditions.

US patent publication 2004/0125773 to Wilson et al., the disclosure of which is incorporated herein by reference, presents the problem of mobile stations at the outskirts of their cells, which suffer from high noise levels and therefore receive lower quality services, such as having lower data rates than mobile stations in the center of a cell. The Wilson publication suggests shutting down an interfering downlink channel in order to reduce interference to data transmissions.

In addition to reducing the network interference, it has been suggested to adapt the transmitted data to the network conditions.

PCT publication WO2006/012911, the disclosure of which is incorporated herein by reference, suggests adapting the encoding of a video stream responsive to the predicted state of the network.

US patent publication 2002/0085536 to Rudrapatna, the disclosure of which is incorporated herein by reference, describes a system in which a mobile station is connected through both packet based and circuit switched channels. Data which is delay sensitive is provided over the circuit switched channel, while delay insensitive data is provided over the packet based channel.

Cellular phones are generally battery operated and it is desired to maximize the utilization time of the battery.

US patent publication 2002/0198013 to Panasik et al., the disclosure of which is incorporated herein by reference, describes a mobile station which moves into an idle state and stops transmitting when attempts to download data are unsuccessful due to the conditions of the network. Such a mobile station is considered to reduce battery power consumption.

U.S. Pat. No. 5,406,613 to Peponides et al., the disclosure of which is incorporated herein by reference, relates to reducing power consumption in receiving data in a system in which a plurality of copies of the data are transmitted. The U.S. Pat. No. 5,406,613 patent suggests determining whether reception of a first copy of the data is error free and stopping to receive further copies if that is the case.

Given the limited bandwidth which is used by a plurality of clients, methods have been devised to determine priorities in allocating bandwidth by a server.

US patent publication 2002/0087623 to Eatough, the disclosure of which is incorporated herein by reference, suggests giving priority to receivers according to various parameters including file size and approximated time required to process the application.

US patent publication 2003/0204603 to Buchanan et al., the disclosure of which is incorporated herein by reference, suggests giving priority to data of a file which has a shortest remaining download time to complete delivery of an image.

U.S. Pat. No. 6,324,570 to Tonchev et al., the disclosure of which is incorporated herein by reference, describes a system for transmitting files to clients. A server gives priority on the one hand to transmission of the file to clients who are in a danger of not receiving the file on time and on the other hand, to clients who will receive the file soonest, based on the conditions of their connection to the server.

US patent publication 2003/0163551 to Riordan, filed Feb. 27, 2002, the disclosure of which is incorporated herein by reference, describes a software downloading method in which a server multiplexes software content directed to a plurality of clients on a shared channel and dynamically adjusts the content multiplexed on the shared channel.

US patent publication 2004/0187124 to Labelle, filed Feb. 11, 2004, the disclosure of which is incorporated herein by reference, describes a method of managing requests in a client server topology, in which each client is assigned a priority.

### SUMMARY OF THE INVENTION

An aspect of some embodiments of the invention relates to a wireless terminal which controls timing of data transmission to the wireless terminal and/or reception of transmissions by the wireless terminal responsive to network and/or device conditions. In some embodiments of the invention, the wireless terminal delays download of data when it determines that network conditions are adverse. The device conditions may include, for example, the battery state of the device.

The network conditions are optionally evaluated according to the transmission rate and/or error rate of one or more previous data blocks.

An aspect of some embodiments of the invention relates to a method of transmitting data in which when the network conditions are adverse, although allowing data transmission, the transmission and/or reception is delayed to a later time at which better network conditions are available. The delay is performed without relation to the bandwidth needs of other transceivers of the network. In some embodiments of the invention, the bandwidth not used due to the delay is not used by a connection of higher or same priority. Transmitting and/or receiving data only when there are favorable network conditions reduces the amount of resources (e.g., battery power, network bandwidth) spent on retransmissions. The method is particularly useful for background transmissions, in which there is no urgency in getting the transmitted data to the receiver.

Optionally, the transmission is performed by a server, which services a plurality of clients. The server determines which of the clients to service, at least partially according to the conditions of the connections to the clients. When the server determines that the conditions to one or more clients are adverse, it delays the transmissions to those clients, even if no other clients can use the bandwidth and the server remains idle or transmitting below the channel capacity. Alternatively to entirely delaying the transmission, the server transmits a very small block of data (e.g., less than 20 bytes, less than 10 bytes or even not more than 3 bytes), which keeps the connection alive but can be transmitted in a single packet or very few packets. Optionally, a server may determine whether to transmit a very small packet or not respond at all, according to an estimated time and/or severity of the adverse conditions.

Alternatively or additionally, the decision to delay the transmissions is performed by the client, without relation to the load on the server. Optionally, the data is transmitted in blocks, which are provided by the server in response to block requests from the client. In accordance with this alternative, the client delays requesting of a next block when the network conditions are adverse. In some embodiments of the invention, the client allows the connection to disconnect, when requesting a next block is delayed. Alternatively, when desired and/or required to keep a connection alive, the client may transmit a request for a very small block of data. The network conditions used in some embodiments in accordance with this alternative may be determined directly by the client or may be determined by the server and transmitted to the client.

In some embodiments of the invention, a data block is transmitted in unicast to a specific wireless terminal. When the network conditions are adverse, the transmission is deferred to a later time. The network conditions are optionally evaluated with regard to the connection to the specific wireless terminal.

In other embodiments of the invention, a data block is transmitted in broadcast (e.g., multicast). The evaluated network conditions are optionally those of the entire cell and when the network conditions are adverse the transmissions are deferred. Optionally, while the transmissions are deferred, the receivers are removed from the broadcast channel or are moved to a sleep mode. Alternatively, the evaluated network conditions are those of a specific wireless terminal and when the conditions are adverse, the wireless terminal stops receiving data for a while, although the data transmission continues. The data which was not received by the wireless terminal because it stopped receiving, is optionally received at a later time in a further broadcast transmission and/or in a unicast data completion session, for example, after the broadcast transmission is completed.

The delay is optionally performed in an application layer, such as an HTTP layer. In some embodiments of the invention, the delay is at least 10 seconds, at least 2 minutes or even at least 30 minutes or even at least 60 minutes.

An aspect of some embodiments of the invention relates to performing a broadcast data transmission in a wireless network, in which a single file is transmitted in a plurality of blocks separated by gaps of at least one minute, at least 5 minutes, at least 8 minutes or even at least 10 minutes, during which the file is not transmitted and the bandwidth is not used by a connection of higher or same priority.

In some embodiments of the invention, the sizes of the gaps and/or the lengths of the transmission periods are predetermined, with equal or non-equal sized gaps. Alternatively, the sizes of the gaps and/or the transmission periods are dynamically chosen according to the network conditions and/or according to the progress state of the broadcast transmission.

Possibly, in the earlier transmission periods, a higher bit rate is used. For example, a high priority transmission channel, (for example, the streaming class) may be used for the earlier transmission periods, and a low priority transmission channel (for example, the background class) may be used in the later periods, when it is known that most of the data was successfully received. Alternatively, the low priority transmission channel may be used at the beginning of the transmission and if the transmission is identified to be too slow, a high priority transmission channel is used.

The use of gaps divides the transmission over times expected to have different network conditions and thus reduces the chances that the transmission will suffer severely from adverse conditions.

An aspect of some embodiments of the invention relates to determining a transmission schedule to or from a wireless terminal, responsive to a status of the battery of the wireless terminal. Optionally, a data server determines an order of servicing data to wireless terminals at least partially according to the battery status of the wireless terminals. For example, transmissions to wireless terminals having low battery power may be provided only when the network conditions are of a high quality, in order not to drain out the battery, which already has a low charge level, on retransmissions. Alternatively or additionally, when the battery level is low, transmission of low priority data is cancelled or deferred until the battery is recharged. In some embodiments of the invention, a wireless terminal manages transmission and/or reception of data according to its battery status.

In some embodiments of the invention, a server is configured not to transmit data to wireless terminals having low battery power levels.

In some embodiments of the invention, the transmissions are deferred when the battery status level is below a relatively high threshold, for example above 10%, above 20% or even above 30%. The delay in these embodiments may be intended to conserve battery power for other, possibly more important, services, such as telephone connections, games, time telling and/or camera operation.

An aspect of some embodiments of the invention relates to a data server adapted to provide data responsive to user requests, which is adapted to adjust the rate at which it receives requests for data.

In some embodiments of the invention, the data server induces clients to generate data requests, when it determines that there are available resources (e.g., bandwidth).

In some embodiments of the invention, the server is adapted to determine the average reception data rate of its clients and adjust the number of clients requesting data responsive to the average reception data rate. Optionally, the data server delays responses to clients and/or provides smaller data portions in response to requests, in order to reduce its load. Alternatively or additionally, when the server and/or network are overloaded, the data server instructs clients to delay further downloads to a specific later time.

An aspect of some embodiments of the invention relates to a data server which dynamically determines a block size to be provided responsive to data requests from clients (e.g., mobile stations or other wireless terminals), according to network conditions and/or server load.

In some embodiments of the invention, the server is adapted to transmit small blocks including less than 100 bytes, less than 10 bytes, or even less than 5 bytes in response to requests from clients to which the server wants to delay download to a later time. Optionally, the server provides responses with a single byte or an empty response with no data at all.

Alternatively or additionally, the server is adapted to provide a block size selected responsive to the status of the client, for example a wireless (e.g., cellular) client. In some embodiments of the invention, clients requesting data do not state an amount of data in their request and the server determines the provided amount. Alternatively, the client indicates a requested amount and the server provides an amount not necessarily equal to that requested.

There is therefore provided in accordance with an exemplary embodiment of the invention, a wireless receiver device, comprising a wireless network interface and a processor configured to manage reception of data files through the network interface, to determine network or wireless receiver device conditions and to delay reception of blocks of a file, responsive to the determined conditions meeting specific requirements, although the determined conditions allow reception of a block without the delay.

Optionally, the processor is configured to delay reception of further blocks of the file responsive to a determination that the network conditions or device conditions are adverse. Optionally, the processor is configured to delay reception for at least 10 seconds, responsive to the adverse network or device conditions. Optionally, the processor is configured to delay reception for at least a minute, responsive to the adverse network or device conditions.

Optionally, the receiver includes a battery which powers the processor and the processor is configured to delay reception responsive to a determination that a battery charge status of the battery is low. Optionally, the processor is configured to delay reception until after the battery is recharged. Optionally, the processor is configured to delay reception responsive to a determination that the battery charge status is below a threshold, which threshold is above 10%. Optionally, the processor is configured to determine a data rate of recently received data and to time further receptions responsive to the determined data rate.

Optionally, the processor is configured to determine the data rate responsive to the time required to receive a previously received block, which block is of the file currently being received or of a different file.

Optionally, the processor is configured to control the timing of reception of blocks by controlling the transmission of requests for further blocks. Optionally, the processor is configured to request the blocks from the server, stating a desired block size and wherein the processor is adapted to request smaller blocks after a reception delay than not after a reception delay. Optionally, the processor is configured to control the timing of reception of blocks by stopping to tune onto a transmission channel to which the receiver was tuned to receive previous portions of the file, which channel continues to carry portions of the data file. Optionally, the processor is configured to delay reception of blocks of a file, even after a first block of the data file was received.

There is further provided in accordance with an exemplary embodiment of the invention, a method of receiving data, comprising receiving an instruction to receive a data file, by a wireless terminal, determining a device state of the wireless terminal or a network quality parameter of transmissions to the wireless terminal and receiving, by the wireless terminal, one or more blocks of the data file at times determined by the wireless terminal responsive to the determining of the device state or network quality parameter, at least one of the determined times being later than allowable by the determined device state or network quality parameter. Optionally, receiving blocks at times determined responsive to the determining comprises transmitting requests for blocks of the file at times determined responsive to the determining.

Optionally, receiving blocks at times determined responsive to the determining comprises tuning at the determined times onto a channel carrying data irrespective of acts of the receiver. Optionally, receiving the instruction comprises receiving a notification that the data file is available for download from a server. Optionally, determining a network quality parameter comprises determining a data rate of reception of one or more previously transmitted blocks of the file. Optionally, receiving blocks at times determined responsive to the determining comprises defining a gap of at least 10 seconds during the reception of the file, during which gap the wireless terminal does not receive the file.

Optionally, determining a device state of the wireless terminal or a network quality parameter comprises determining a battery charge level of the wireless terminal. Optionally, determining a device state of the wireless terminal or a network quality parameter comprises determining whether the battery is currently being recharged.

There is further provided in accordance with an exemplary embodiment of the invention, a method of data transmission, comprising transmitting at least one first data block of a data file, from a transmitter, determining a network quality parameter of a network path on which the at least one first data block is transmitted and delaying the transmission of further data blocks of the file responsive to the network quality parameter, although the network allows data transmission by the transmitter, without using the bandwidth of the transmission for transmissions having at least the same priority as the data file.

Optionally, determining the network quality parameter is performed by the receiver. Alternatively, determining the network quality parameter is performed by the transmitter. Optionally, delaying the transmission is initiated by the receiver. Alternatively, delaying the transmission is initiated by the transmitter. Optionally, delaying the transmission by the transmitter comprises transmitting a packet with less than 20 bytes to the receiver responsive to a request for a data block. Optionally, delaying the transmission comprises delaying responsive to adverse network conditions.

Optionally, the transmission comprises a unicast transmission or a broadcast transmission. Optionally, delaying the transmission comprises delaying for at least 10 seconds. Optionally, delaying the transmission comprises delaying although the network allows transmission at a rate of at least 1 kilobit per second. Optionally, delaying the transmission comprises delaying although the network allows transmission at a rate of at least 10 kilobits per second. Optionally, delaying the transmission comprises delaying although the network allows data transmission above a minimal reception rate defined for the transmission.

There is further provided in accordance with an exemplary embodiment of the invention, a method of broadcast transmission of a file, comprising providing a data file for broadcast transmission, transmitting a first block of the file on a broadcast channel, providing a transmission gap of at least one minute during which data from the file is not transmitted on the broadcast channel, although the network conditions allow data transmitted by the transmitter to be received and transmitting a second block of the file on the broadcast channel, after the transmission gap.

Optionally, the method includes receiving the first and second blocks by a plurality of units from the broadcast channel. Optionally, providing the transmission gap comprises providing a gap of at least 10 minutes. Optionally, the method includes transmitting a notification on a time at which the transmitting of the second block will begin. Optionally, providing the gap comprises determining network conditions of the transmission of the first block and providing the gap if the network conditions are adverse. Optionally, providing the gap comprises providing the gap at a time selected without relation to current network conditions. Optionally, providing the transmission gap comprises providing a gap during which the bandwidth of the channel is not used for data of same or higher priority rating than the data file. Optionally, providing the transmission gap comprises providing the gap regardless of whether there is data of another file to transmit on the channel.

There is further provided in accordance with an exemplary embodiment of the invention, a wireless receiver device, comprising a wireless network interface, a battery and a processor configured to determine a status of the battery and to manage reception of data files through the network interface, wherein the processor is configured to delay reception of blocks of a file responsive to a determination that the battery charge status meets a predetermined condition, while continuing operation of one or more other tasks of the wireless device.

Optionally, the processor is adapted to delay reception responsive to the battery status being below a threshold which is above 15% of the battery capacity. Optionally, the one or more other tasks comprise allowing telephone calls.

There is further provided in accordance with an exemplary embodiment of the invention, a method of data transmission, comprising determining a status of the battery of a wireless terminal; and controlling a transmission of a data file to the wireless terminal responsive to the battery status, while allowing continuation of one or more other tasks of the wireless terminal.

Optionally, controlling the transmission comprises controlling by the wireless terminal.

Optionally, controlling by the wireless terminal comprises controlling the timing of requests for blocks of the file for transmission. Optionally, controlling the transmission comprises delaying reception of the data file until the battery is recharged. In some embodiments of the invention, controlling the transmission comprises setting a minimal data rate threshold for continuing transmission of the file, responsive to the battery status. Optionally, the minimal data rate threshold is a function, which increases as the battery charge level decreases.

There is further provided in accordance with an exemplary embodiment of the invention, a method of data distribution by a server, comprising receiving requests for data, by the server, transmitting blocks of data to units sending the requests from the server, determining an average reception data rate of the units receiving data from the server and inducing adjustment of the number of units requesting data, responsive to the determination of the average reception data rate.

Optionally, inducing adjustment of the number of units requesting data comprises inducing units to request data responsive to a determination that the average reception rate is high. Alternatively or additionally, inducing adjustment of the number of units requesting data comprises inducing units to delay requesting data to a later time responsive to a determination that the average reception data rate is low.

Optionally, inducing units to delay requesting data to a later time comprises transmitting to the units a response including at least one byte of payload data but less than 100 bytes of payload data or even less than 10 bytes of payload data. Optionally, inducing units to delay requesting data to a later time comprises transmitting to the units an error response, a negative response or a delay response. In some embodiments of the invention, the response does not contain data.

There is further provided in accordance with an exemplary embodiment of the invention, a method of data distribution by a server, comprising receiving requests for data, by the server, transmitting blocks of data to units sending the requests from the server, determining an operation parameter of the server and inducing one or more units to send requests for data, responsive to the determined operation parameter.

Optionally, inducing the one or more units to send requests for data comprises sending the units an SMS message. Optionally, the operation parameter comprises a current average payload data rate of the units receiving data from the server.

There is further provided in accordance with an exemplary embodiment of the invention, a method of data distribution by a server, comprising receiving requests for data, by the server, transmitting blocks of data to units sending the requests from the server, determining an operation parameter of the server, determining by the server that the load on the server needs to be decreased responsive to the operation parameter and transmitting to one or more of the units an indication of a later time at which to request data, responsive to the determination that the load on the server needs to be decreased.

Optionally, transmitting the indication of a later time comprises transmitting to units responsive to requests received from the units. Optionally, transmitting to one or more of the units an indication of a later time at which to request data comprises transmitting to the units a response containing no data. Optionally, transmitting the indication of a later time comprises transmitting to units not responsive to requests received from the units. Optionally, determining the operation parameter comprises determining a current average payload data rate of the units receiving data from the server and/or a number of connections handled by the server.

There is further provided in accordance with an exemplary embodiment of the invention, a server, comprising a network interface, a processor configured to receive requests for data and transmit through the network interface data in response to the request, to determine an average reception data rate of units receiving the data and to transmit messages which are adapted to change the load on the server, responsive to a determination that the average reception data rate is outside a desired range.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a cellular network, in accordance with an exemplary embodiment of the present invention;

FIG. 2 is a flowchart of acts performed by a mobile station in receiving a file, in accordance with an exemplary embodiment of the invention;

FIG. 3 is a flowchart of acts performed in controlling the load on a server, in accordance with an exemplary embodiment of the invention; and

FIG. 4 is a schematic block diagram of a transmission with predetermined gaps, in accordance with an exemplary embodiment of the invention.

### DETAILED DESCRIPTION OF EMBODIMENTS

### System

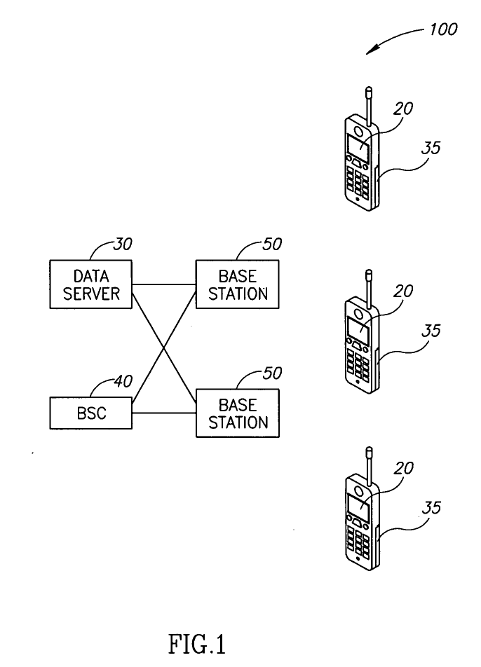

FIG. 1 is a schematic illustration of a wireless network 100 (e.g., cellular), in accordance with an exemplary embodiment of the present invention. Network 100 includes a plurality of base stations 50, which transmit signals to mobile stations 20 in their vicinity. A data server 30 provides data files that are downloaded and/or transmitted to mobile stations 20. The data files are optionally broken into transmission blocks which may be encoded, for example using a forward error correction (FEC) scheme and/or may be encrypted. In some embodiments of the invention, the blocks are provided in packets (e.g., IP packets), which are formed of a header portion and a payload portion which carries data from the block.

At least some of mobile stations 20 are optionally powered by a battery 35, which has a limited operation span until it needs to be recharged. In some embodiments of the invention, some or all of the mobile stations 50 have a relatively large memory, for example of at least 16 MBytes, at least 256 MBytes, or even at least 2 Gigabytes.

Optionally, the files provided by data server 30 are transmitted on a background channel. In some embodiments of the invention, the background channel has a lower priority than real time transmission channels in network 100. The transmitted data files are optionally not required urgently, for example being allowed to be provided within more than 15 minutes, more than an hour or even more than a day or three days, from the time they are provided to network 100 for transmission. In some embodiments of the invention, the data files are downloaded based on outstanding general instructions to download files of predetermined characteristics and not responsive to particular user instructions.

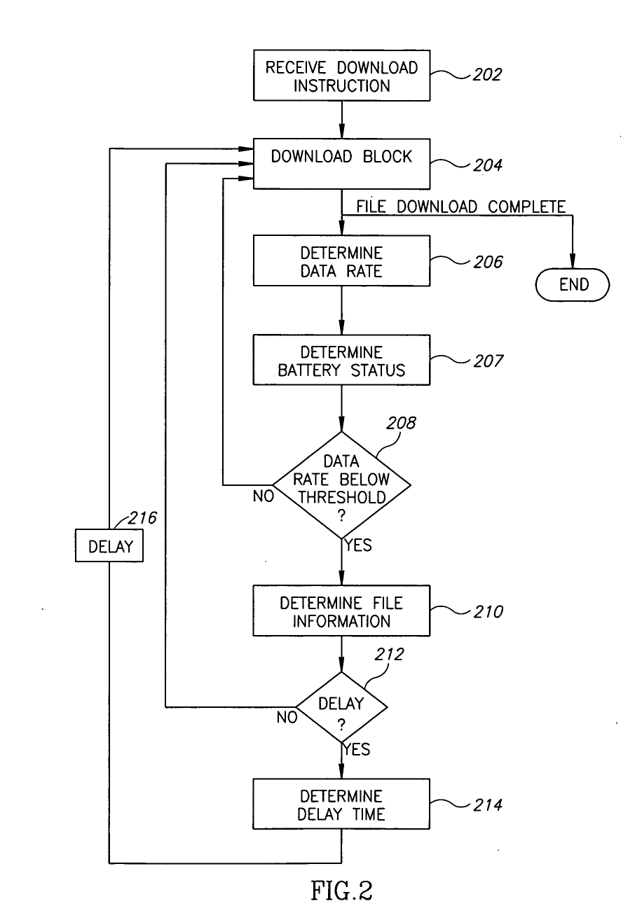

FIG. 2 is a flowchart of acts performed in receiving data by a mobile station, in accordance with an exemplary embodiment of the invention. Upon receiving (202) an instruction to download a data file, mobile station 20 downloads (204) a block of the file. The mobile station 20 determines (206) the data rate (or other network quality parameter) of the download of the block. Alternatively or additionally, mobile station 20 determines (207) its battery status. Optionally, if (208) the data rate is below a delay threshold, mobile station 20 determines (210) file information (e.g., priority, number of downloaded bytes, number of bytes left to complete the download) of the downloaded file. According to the data rate, battery status and/or the file information, mobile station 20 determines whether (212) to delay the further download of blocks of the data file and possibly (214) the duration of the delay time.

For example, when the data rate is low, the persistent download of data may require many retransmissions, which could lead to excess battery utilization and/or usage of excess transmission bandwidth. Furthermore, since the battery utilization depends mainly on operation time and not on data rate, a low data rate means the mobile station is activated for lengthy periods of time to transfer the data, thereby wastefully consuming the battery power of the mobile station. Additionally, slow data rates can use the network inefficiently due to the relatively larger overhead for control channels.

By delaying the download, when possible, until a higher data rate can be achieved, or until there is a high chance a higher data rate will be achieved, the download may be performed in a more efficient manner.

After the delay time (216), or immediately after the block was received if it was decided not to delay the transmission, further blocks are downloaded (204) until the entire file is received.

In some embodiments of the invention, after the delay period, server 30 provides relatively small blocks until it is determined that the conditions have actually changed, e.g., the data rate is at a normal level. Optionally, the server determines when a requesting mobile station 20 is after a delay period and therefore is to be provided small blocks, based on the previous time at which a request was received from the mobile station or based on an indication in the request received from the mobile station. Alternatively, the mobile station transmits a request for a relatively small block without the server being notified of the reason for requesting a small block. Optionally, the small block is less than 70%, less than 50% or even less than 30% of the size of blocks transmitted in normal conditions. In some embodiments of the invention, the small block transmitted after a delay period is smaller than 400 bytes, smaller than 100 bytes, or even smaller than 50 bytes.

Optionally, the method of FIG. 2 is performed by an application layer of the mobile station 20, possibly an application layer above HTTP and/or TCP. Alternatively, the method of FIG. 2 is performed in lower protocol layers of mobile station 20, for example a transport layer such as TCP or a low application layer such as HTTP.

### Download Instruction

Referring in more detail to receiving (202) the download instruction, in some embodiments of the invention the instruction is received from data server 30. Possibly, the instruction includes indication of a time period during which the data file can be downloaded and/or other download timing information, such as preferred download times. Server 30 optionally distributes the instructions to mobile stations 20 over time, thus distributing the load and preventing congestion at a single time point. In some embodiments of the invention, when an instruction to download is received, mobile station 20 determines if to carry out the instruction, based on previously programmed user settings, network conditions and/or based on the state of the mobile station 20 (e.g., the charge level of battery 35). For example, when the provided files relate to various subject categories, the user may set for each subject category, an importance level that determines whether the file is downloaded in view of the network conditions and/or mobile station state (e.g., battery charge level). For example, files of subjects defined as being of low importance may be set to be downloaded automatically upon receiving an instruction from server 30 only if the network conditions and/or mobile station state is very high, while files of high importance subjects (e.g. emergency alerts) may be downloaded even in relatively low rated conditions.

Alternatively to receiving the instruction from data server 30, the instruction to download is received from a user of the mobile station. In some embodiments of the invention, the instruction may optionally include download timing instructions and/or file information, such as a rating of the importance of the content to the user.

### File Type

The downloaded file may be of substantially any size, including small files of possibly tens or hundreds of bytes, as well as large video clips including more than 50 Kbytes, more than 200 Kbytes, more than 1 Megabyte, more than 10 Megabytes or even more than 100 Megabytes. In some embodiments of the invention, the downloaded file is of a size of several Gigabytes. The file may include substantially any type of content including, for example, one or more of still images, voice files, video clips (e.g., podcasts, entire episodes), video movies, advertisements, software updates, game data and text messages. A file may include a single type of content or may contain a mix of sub-files of a plurality of different content types.

### Determining Data Rate

Referring in detail to determining (206) the download data rate, in some embodiments of the invention, the data rate is calculated by mobile station 20 as the total size of the block divided by the total reception time of the block. Alternatively, the data rate is calculated as the amount of data received during a predetermined period, optionally a period including less than a single block or a period including a plurality of blocks. The term data rate relates only to the payload of the transmitted packets, as received by the receiver, after any retransmissions (which lower the data rate). In contrast, the term bit rate relates to both the headers and the payload.

Possibly, the data is transmitted using a transport protocol which keeps track of the amount of bytes received (e.g., TCP) and the information on the amount of received data is taken from the transport protocol.

In some embodiments of the invention, mobile station 20 uses an internal clock in determining the transmission time. Alternatively or additionally, time stamps of the received packets are used in determining the time.

Optionally, the data rate is determined by an application layer process on mobile station 20. Alternatively or additionally, the data rate or some of the data used in its determination, such as error rate or radio conditions, is provided by a low level communication layer of mobile station 20.

Optionally, if a block download is aborted for any reason, the determined data rate of the block is considered to be 0, for determination (212) of whether to delay download of further blocks. The download may be aborted, for example, as discussed below due to the data rate being below a cease threshold and/or due to a server action, e.g., by disconnecting the TCP session or by returning an HTTP response code such as 503 (Service Unavailable). Other reasons for aborting a block download include, for example, movement of the downloading mobile unit into a zone which lacks service or has low quality coverage.

In some embodiments of the invention, the data rate is determined for each block downloaded. Alternatively, the determination (206) of the data rate is performed periodically, for example every five or ten downloaded blocks. In some embodiments of the invention, the frequency of determination (206) of the data rate is higher when mobile station 20 is in movement or otherwise when the network conditions are expected to change frequently. Optionally, the data rate is determined based on a single block most recently transmitted. Alternatively or additionally, the data rate is determined based on download times of a plurality of recently downloaded blocks (e.g., an average data rate of the recently downloaded blocks) and/or based on the data rate of a previously received block, for example a block received completely at least one second or at least five seconds before the determination.

Optionally, the data rate determination is based only on timing data of blocks of the file for which the determination is performed. Alternatively, the determination (206) of the data rate is based at least partially on the data rate of one or more blocks belonging to a different file than the file for which the determination whether to delay is performed.

### Alternative Network Condition Measures

Alternatively or additionally to determining the data rate, one or more other measure are used to reflect the network condition. For example, the ratio between the number of bytes transmitted (including retransmissions) and the number of bytes in the block may be used to evaluate the network conditions. In another exemplary embodiment of the invention, the number or percentage of lost data packets (erroneously received or not received at all) or the number or percentage of bytes in lost packets is used as a measure of the network conditions.

In some embodiments of the invention, for simplicity, only a single measure of the network conditions is used. In other embodiments of the invention, a plurality of network condition measures are used, determined by a single unit or by a plurality of units, in order to get a better estimate of the network conditions.

In some embodiments of the invention, alternatively or additionally to determining the network conditions from the transmitted data, the network conditions are determined from a short test sequence that is transmitted periodically, based on previously transmitted data and/or from the signal strength required for communication with the base station 50. Possibly, one or more circumferential parameters (e.g., whether mobile station 20 is transmitting voice) are used in estimating the network conditions of the mobile unit. Such determination is possibly more accurate, but may also be more complex.

### Network Conditions Estimation by Server

Alternatively or additionally, mobile station 20 does not determine the measure or measures of the network conditions, but rather receives indications of the conditions from a remote unit, such as base station 50, a base station controller 40 or server 30. The determination of the network conditions by server 30 may be performed based on the communications with mobile station 20, using any of the methods described above and/or based on general parameters relating to communications with a plurality of mobile stations 20 in a network region, e.g., a base station cell.

In some embodiments of the invention, server 30 calculates an average data rate over a plurality of blocks, for example when mobile station 20 is serviced by a proxy and the amount of data provided to mobile station 20 is reported by the proxy upon completion of delivery of a block (e.g., in authorization requests).

Alternatively or additionally, for each request received, the server checks whether a response was provided for a previous block of the same file for the same client. If such a response was provided, the server calculates the average data rate for the client as

Data rate=Bₚᵣₑᵥ/(T−Tₚᵣₑᵥ)

where Bₚᵣₑᵥ is the previous block size and T-Tₚᵣₑᵥ is the time between receiving the previous request and the current request.

### Delay Determination

Referring in more detail to determining whether (212) to delay the download, in some embodiments of the invention, the determination of whether to delay the download depends on the current battery status of the mobile station 20, alternatively or additionally to depending on the network conditions. Optionally, when the battery charge level is low, possibly when it is estimated that the download of the file cannot be completed with the current battery charge level, the download of the file is cancelled or deferred until the battery is recharged. Alternatively or additionally, for example for high importance files, when the battery charge level is low, the transmission is not delayed, so that the file transmission is completed before the battery is completely drained out. In some embodiments of the invention, when the battery charge level is relatively high, the transmission is not delayed as it is not sufficiently important to conserve battery power.

In some embodiments of the invention, the battery charge level is compared to a threshold and low importance data is not downloaded if the battery level is below the threshold. Optionally, the threshold is above 5%, 10% or even 25% of the battery power capacity, so as to leave sufficient power for other tasks of mobile station 20. Alternatively or additionally, the threshold is above a battery charge amount which allows talking on the telephone for at least a minute or even at least 3 minutes.

Alternatively or additionally, the determination on whether to download a file depends on whether mobile station 20 is currently being recharged. Optionally, when mobile station 20 is being recharged it attempts to download files under any network conditions, or under network conditions up to a relatively harsh level. In some embodiments of the invention, when mobile station 20 identifies that it was plugged in for recharge or that it has been recharged sufficiently (e.g., for at least a predetermined period and/or up to a predetermined level), the mobile station resumes any file downloads that were postponed and/or shortens delays that were decided on before the mobile station 20 was connected to a power source and/or recharged. Optionally, the delay is shortened only if the network conditions are above a predetermined minimal level and/or the delay was not due to the file content.

As mentioned above, in some embodiments of the invention, file information is used in determining whether to delay the download. Optionally, the file information includes an expiration time of the file, i.e., a time deadline until which the file is to be received, a size of the file and/or an importance rating of receiving the file by a specific time or as soon as possible and/or of receiving the file at all. For example, the user may define the importance of different types of data to him (e.g., sports, news, clips) and each data type is assigned its own importance rating. Possibly, the importance of the data file indicates the urgency and/or importance in receiving the data file. In some embodiments of the invention, data files are assigned a final deadline by which they are to be downloaded. If the file is not downloaded by the designated deadline, the attempts to download the file are aborted. According to these embodiments, the importance indication of the file also indicates the importance of receiving the file at all.

In determining whether to delay, mobile station 20 optionally calculates the remaining time margin between the expiration time of the file and the expected completion of receiving the file, assuming, for example, a maximal transmission rate with no errors, an average transmission rate or a most probable transmission rate. When the remaining time margin is below a margin threshold, the transmission is optionally not delayed unless the data rate is very low, for example, such that the chances of the file being received are slight and/or the content is of low importance.

In an exemplary embodiment of the invention, a block is allowed to be delayed if the remaining portion (RP) of the file, which is equal to the total size of the file (M) minus the size of the portion of the file already received (B), is smaller than the amount of data that can be transmitted in the time (T_{end}−t) remaining until transmission of the file must be completed, allowing for a safety margin (I_{safe}), taking into account a minimal transmission rate Rₘᵢₙ. That is, if the condition M-B<Rₘᵢₙ*((T_{end}−I_{safe})−t) is met, the transmission may be delayed if the current data rate (determined in act 206) is low and/or if the battery charge is low. I_{safe} possibly depends on the total size of the file M or on the remaining portion of the file M-B.

In some embodiments of the invention, each transmitted block of the file includes some or all of the file information. Alternatively or additionally, the file information is provided to mobile station 20 at the beginning of the download or at any other time.

Possibly, the determination (212) relates to each one of the network conditions, battery status and file information separately. If the network conditions indicate the transmission is to be delayed and the mobile stations status and the file information do not object to a delay, the transmission is delayed. Optionally, in accordance with these embodiments, the data rate is compared to a fixed delay threshold. Alternatively, the determination of whether to delay is a combined function of the data rate and at least one of the mobile station status and the file information. In some embodiments of the invention in accordance with this alternative, the data rate is compared to a delay threshold which is selected responsive to the file information and/or mobile station state. For example, urgent files may require a lower data rate than non-urgent files, to warrant delay.

In an exemplary embodiment of the invention, the determination on delay is performed separately for network conditions and for the state of the mobile station. Optionally, if one of the reasons for delay is met, the transmission is delayed.

### Delay Period

In an exemplary embodiment of the invention, the delay period used is as large as possible, while leaving a sufficient safety margin, in order to defer as much as possible from the current bad conditions. Alternatively, the delay period used is selected between about 10%-30% of the available time, so as to use a relatively large delay, but still leave room for additional delays if necessitated by continuing adverse conditions. In an exemplary embodiment of the invention, the delay is calculated as:

T_{delay}=Max [Dₘᵢₙ,Min [Dₘₐₓ,(T_{d}−t)/4]]

where Dₘᵢₙ is a minimal delay time used, Dₘₐₓ is a maximal delay time used, t is the current time and T_{d} is a latest time to which the pull of the file can be delayed leaving a safety margin and assuming a reception rate of at least Rₘᵢₙ. In an exemplary embodiment of the invention, T_{d} is given by

$${T}_{d} = \frac{B - [ M - {R}_{min} \cdot ( {T}_{end} - {I}_{safe} ) ]}{{R}_{min}} .$$

It is noted that if T_{d} is negative, further blocks should not be delayed.

In some embodiments of the invention, the minimal delay Dₘᵢₙ is greater than 20 seconds, or even greater than 50 seconds, so that there is a reasonable chance that the conditions change after the delay is over. In some embodiments of the invention, Dₘᵢₙ is less than 10 minutes or even less than five minutes, allowing delay for relatively short periods, when so required. It is noted, however, that in some embodiments of the invention a shorter minimal delay, for example as short as 10 seconds or even 5 seconds is used, for example in cases in which the total time allocated for delivering the file is relatively short or otherwise there is a relatively high probability that the file may not be delivered on time. The maximal delay is optionally greater than 20 minutes or even greater than 30 minutes, so as to allow for long delays which are expected to provide substantially different conditions after the delay. Optionally, the maximal delay is not too long, e.g., is not greater than 2 hours or even not greater than an hour.

In an exemplary embodiment of the invention, the minimal delay is 15 seconds and the maximal delay is 15 minutes. In another exemplary embodiment, the minimal delay is 1 minute and the maximal delay is 50 minutes.

In some embodiments of the invention, the length of the delay is also a function of whether a delay period was previously used in download of the current file. Optionally, if a second delay is required for a same file, the second delay period is longer, as the earlier delay was not sufficient to overcome the problematic conditions.

Optionally, in some embodiments of the invention, an additional random delay value is added to the delay period determined in accordance with any of the above methods or an entirely random delay value is used. Use of a randomly selected delay period is advantageous, for example, to avoid a large number of terminals experiencing reception problems at the same point in time (e.g. if they are in the same cell or area) delaying to a same later time at which the problems are expected to continue due to the large number of concurrently downloading units. In an exemplary embodiment of the invention, the delay period is chosen randomly as a uniformly distributed value in the interval [0, Dₘᵢₙ]. Alternatively or additionally, the random delay period selected from the interval [0, Dₘᵢₙ] is added to a non-randomly selected interval.

Possibly, during the delay, no data is transmitted on the connection. In some embodiments of the invention, the connection is allowed to disconnect and is re-established when the delay is over. Alternatively, a minimal amount of data is transmitted by the application layer on the connection during the delay period in order to prevent it from being disconnected and requiring reconnection. For example, during the delay period, mobile station may request a minimal sized block (e.g., less than 10 bytes), just in order to keep the connection alive. In some embodiments of the invention, the delay period is short enough to prevent closing of the connection. It is noted, however, that in some cases the transport protocol (e.g., TCP) sends keep alive packets on the connection, and the application layer does not send additional keep alive packets.

### Frequency of Determination

In some embodiments of the invention, the determining (206) of the data rate and the determination on whether (212) to delay the further download of blocks is performed after reception of each block. Alternatively, the determination of whether to delay transmission is performed less often, for example periodically after download of a predetermined number of blocks, e.g., at least five blocks or at least ten blocks. In some embodiments of the invention, the determination (214) of the delay time is performed intermittently in irregular intervals, possibly selected randomly.

### Stopping Download of a Block

In some embodiments of the invention, in addition to determining the average data rate after each block is received or after a plurality of blocks are received, mobile station 20 continuously monitors the progress of the download of the block while it is being downloaded. Optionally, if the current data rate is below a cease threshold, the download of the block is aborted as the rate is too slow to be worthwhile to continue the download.

Possibly, the cease threshold is dynamically adjusted according to the percentage of the block already received. In general, the closer to full transfer of the file, the lower the cease threshold. Alternatively or additionally, the cease threshold depends on the file information and/or the mobile station status, according to any of the functions discussed regarding the delay threshold.

In an exemplary embodiment of the invention, the cease threshold is given by the equation: R_{cease}(b)=R_{delay}*(1+const*b/B), where R_{delay} is the delay threshold which would cause delay in requesting the block, b is the number of bytes already downloaded, B is the size of the block and const is a constant that indicates the extent to which the ceasing of download in the middle of a block is discouraged. In an exemplary embodiment of the invention, const is between 0.5-3, for example 2.

Alternatively or additionally, reception of a data block is aborted if no data is received within a certain time limit.

### Block Size

The downloaded blocks may have substantially any convenient size. In some embodiments of the invention, the block size is dynamically selected responsive to the network conditions (e.g., the average bit rate), in order to maximize throughput and/or to minimize power utilization of the battery of the mobile station. Optionally, the block size is selected responsive to the expected chance of the transmission of a block being disrupted or discontinued, possibly forcing retransmission of the entire block.

Referring in more detail to downloading (204) the block, in some embodiments of the invention, for each block, mobile station 20 transmits a request for the block to server 30 and the server responds with the block. In some embodiments of the invention, mobile station 20 indicates a desired size of the block. Optionally, server 30 always responds with a block of the desired size. Alternatively, server 30 responds with a block size determined according to its current load. For example, server 30 may respond with a block of a size equal to the amount of data it can provide according to its load, network bandwidth and/or number of clients it can support.

In some embodiments of the invention, server 30 may respond with a very small block, such that most of the bytes transmitted are packet headers or other overhead, for example in order to purposely reduce the data rate to a mobile station 20. Optionally, in accordance with this alternative, when server 30 wants one or more mobile stations 20 to delay the download server 30 provides the mobile station 20 a small block, which decrease the measured download rate, and hence may cause the mobile stations 20 to delay the download. In some embodiments of the invention, the small blocks include less than 100 bytes, less than 20 bytes or even less than 5 bytes. Further alternatively, the requests from mobile stations 20 do not indicate a desired block size and server 30 determines a block size to be provided to the mobile station. Reasons for server 30 causing a mobile station 20 to delay its download are mentioned below with regards to the server acts.

### Push Configurations

Alternatively to mobile station 20 downloading the file in a pull configuration, the file is provided in a unicast push configuration. For example, the file may be provided using a standard push protocol, such as ALC or FLUTE (described in IETF RFC 3926, the disclosure of which is incorporated herein by reference). When mobile station 20 determines that the next block should be delayed it optionally notifies the server of the desired delay. Alternatively, the mobile station 20 imposes the delay by not acknowledging the receipt of the previous block, until the end of the delay period. The delay period is possibly chosen to be short enough not to cause problems due to delaying the acknowledgement.

In other embodiments of the invention, the data file is provided in a broadcast, multicast or passive unicast transmission (i.e., a unicast transmission in which the receiver does not provide real time acknowledgments or other feedback), using any protocol known in the art (for example, the above mentioned standard push protocols) and the receiving mobile station 20 possibly has no control over the timing of the transmission. In these embodiments, the determination of whether to delay the reception of the data optionally takes into account the possibility of reconstructing the data which will not be received during the delay period. For example, if the broadcast data is retransmitted a plurality of times and/or using a forward error correction code, during the early transmissions the reception may be temporarily stopped for a delay period when the effective data reception rate (i.e. the actual rate of the data received) is below a first relatively high threshold. In contrast, during the later transmissions the reception is optionally temporarily stopped only when the data rate is below a second, very low, threshold. The importance rating of the data optionally indicates the importance of receiving the data file during the broadcast transmission. In some embodiments of the invention, mobile station 20 may cease receiving low importance files even if they will not be recovered later, if the data reception rate is low and/or the battery charge status is low.

In some embodiments of the invention, the broadcast transmission is provided on a broadcast channel, which does not have provisions for feedback for power control or acknowledgement.

### Server Acts

In some embodiments of the invention, the method of FIG. 2 is performed entirely by mobile station 20, without any need for cooperation from server 30 and hence can be performed with a standard server without adaptations. Alternatively, server 30 participates in the timing of the download, for example using any of the methods now described.

Possibly, alternatively or additionally to mobile station 20 determining the data rate and delaying the download of the data, server 30 determines the data rate and controls the delaying of the transmission of the data file. Optionally, the delaying by the server is performed by notifying the mobile station 20 that a delay was imposed and that it should defer requests for data until after the delay period. This notification is referred to herein as a delay response. Alternatively, server 30 simply does not respond to data requests of the mobile station 20 until after the delay period is over. Further alternatively, server 30 responds with an empty response containing no real data or a small size response including very little real data, e.g., less than 10 bytes. In some embodiments of the invention, the empty response comprises a negative response (e.g., an HTTP 200 response with XML formatted negative response) or an error response (e.g., an HTTP response with code 503). Transmitting a small size response or empty response causes the mobile station 20, in accordance with some embodiments of the present invention, to calculate a low bit-rate and to possibly delay the next block pull.

### Server Load Regulation

In some embodiments of the invention, when server 30 needs to provide a file to a large number of mobile stations 20, the server regulates the number of mobile stations downloading the file at any time, in order to prevent congestion of the network and/or overload of server 30.

In some embodiments of the invention, server 30 is configured to maintain the number of mobile stations 20 it services within an interval [Cmin, Cmax]. Alternatively or additionally, server 30 is configured to maintain the bandwidth it uses for responding to download requests of a specific file, or of all files, within an interval [BWmin, BWmax]. Further alternatively or additionally, server 30 maintains the average data rate and/or the minimal data rate of each client, within a predetermined range [DRmin, DRmax]. Alternatively or additionally, server 30 maintains the overall average data rate of all clients it services, within a predetermined range [DRmin, DRmax]. These intervals may be defined for all mobile stations 20 serviced by the server 30 or may be defined for mobile stations 20 of a specific area, a specific QoS rating, a specific service or a specific service profile.

In an exemplary embodiment of the invention, server 30 keeps the average transmission or reception data rate to each client, over the group of currently serviced clients, within a predetermined range, for example a range having a lower limit above 20 kilobits per second, above 50 kilobits per second or above 100 kilobits per second. In some embodiments of the invention, the lower limit is above 500 kilobits per second. The upper limit is optionally lower than 1 Mbit per second, lower than 200 Kbit per second or even lower than 100 Kbit per second. It is noted, however, that other limits for the bit-rate ranges may be used.

When the load on server 30 is too low, for example when the number of mobile stations 20 requesting a download is below Cmin or the average data rate of all the clients is above or could be above, DRmax, server 30 optionally sends messages to some of the mobile stations 20 to urge them to download the file immediately or sooner than planned, in order to utilize the currently available network resources. Optionally, the download urging messages comprise SMS messages. Alternatively or additionally, the download urging messages comprise IP packets possibly using SIP (Session Initiation Protocol), described in IETF RFC 3261, the disclosure of which is incorporated herein by reference. In some embodiments of the invention, server 30 manages an ordered list of mobile stations 20 to receive the provided file. The order in the list may be random or may be based on priority (e.g., giving precedence in transmitting inducing messages to clients having a high quality of service rating), current location or other parameters. Alternatively or additionally, when it is required to induce mobile stations 20 to request the file, download inducing messages are transmitted to mobile stations 20 in areas having current high quality network conditions (e.g., low network utilization).

When, on the other hand, the load on server 30 is too high, server 30 optionally ignores requests for the file from one or more of the mobile stations or otherwise reduces the number of mobile stations 20 currently downloading. Alternatively or additionally, when server 30 is overloaded it causes some of the mobile stations 20 to delay their download to a later time, for example by providing data at a very low data rate which will cause the mobile station to delay sending requests to a later time, as described hereinabove. Further alternatively or additionally, when the load on server 30 is too high, the server returns negative responses to download requests of new files whose download did not begin already and/or to download requests of mobile stations not recently requesting download. Further alternatively or additionally, any of the methods described above as suitable for delaying transmissions by the server may be used by server 30 to reduce its load.

In some embodiments of the invention, the mobile stations 20 to be delayed or otherwise not to be serviced are those that most recently began to download the file, preferably those that did not receive any portion of the file yet. Alternatively or additionally, the mobile stations that are delayed are mobile stations 20 with a low quality of service (QoS) rating. Further alternatively or additionally, when a need arises, server 30 reduces the block size it provides to all or some of the mobile stations 20, until some of the mobile stations delay their request, because their data rate is too low.

In some embodiments of the invention, server 30 monitors the network conditions, mobile station conditions and/or file importance ratings and accordingly determines which mobile stations 20 to delay. For example, server 30 may impose a delay on mobile stations having a low battery charging level. In accordance with this example, server 30 selects to delay transmissions to those mobile stations for which it is their interest to delay the transmissions. In another exemplary embodiment of the invention, server 30 delays transmissions to those mobile stations 20 whose owners gave the file a relatively low importance rating. Alternatively or additionally, server 30 delays the transmissions to mobile stations 20 in areas having adverse network conditions, for example in areas that are known to have a relatively low average data rate.

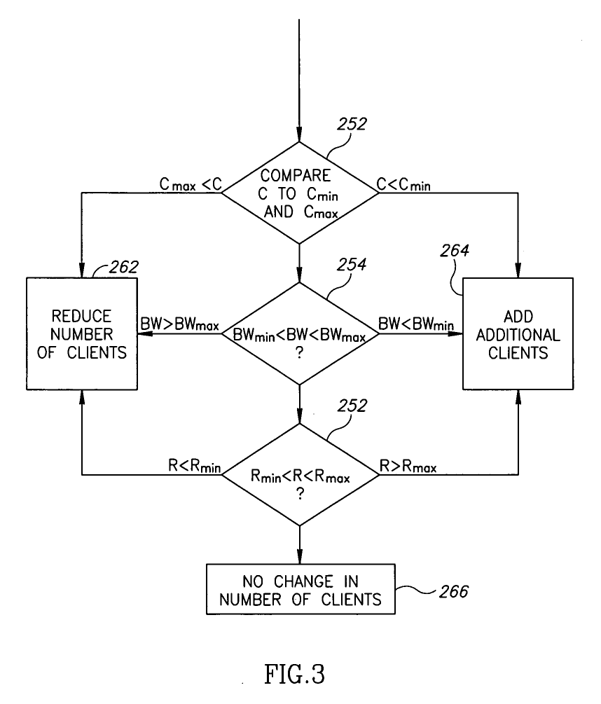

FIG. 3 is a flowchart of acts performed in controlling the load on a server, in accordance with an exemplary embodiment of the invention. The server continuously or periodically performs one or more tests to determine whether the number of clients is within a desired range. In the example in FIG. 3, the number of connections C is compared (252) to the range Cmin and Cmax. If (252) the number of connections is greater than Cmax (C>Cmax), the number of connections is reduced (262). If (252) the number of connections is smaller than Cmin (C<Cmin), the number of connections is increased (264) using any of the above discussed methods. Otherwise, the bandwidth BW of the transmissions of the server is compared (254) to minimal and maximal ranges. If (254) the bandwidth BW is smaller than BWmin, the number of connections is optionally increased (264), so that server 30 is not utilized at a substantially lower level than considered efficient. On the other hand, if (254) the bandwidth BW is greater than BWmax, the number of connections is reduced (262). The average rate (R) of the connections handled by the server, is calculated as the total received data rate of the data provided by the server divided by the number of connections handled by the server. If (256) the average rate is smaller than a minimal average rate (R<Rmin), the number of clients is reduced (262). If (256) the average rate is greater than a maximal average rate (R>Rmax), additional connections are added (264). Otherwise, the number of connections is not changed, possibly changing each terminated connection with a corresponding new connection.

In some embodiments of the invention, the method of FIG. 3 is carried out substantially continuously. Alternatively, the method is performed periodically, for example once every second or every ten seconds.

### Server Broadcast

In some embodiments of the invention, server 30 monitors the network conditions of a broadcast (e.g., multicast) transmission and accordingly delays the entire broadcast transmission when conditions are non-favorable. In some of these embodiments, server 30 receives feedback from some or all of the receivers and accordingly determines the conditions of the network. Alternatively or additionally, server 30 monitors the network conditions without relation to the specific broadcast transmission, for example monitoring unicast data transmissions and/or voice connections in the monitored cell. When the data rate is low and/or the conditions are otherwise considered adverse, server 30 optionally notifies the receivers in the broadcast transmission that the broadcast is delayed until a given time. In some embodiments of the invention, during the entire delay, server 30 repeatedly transmits a notification on the delay, so that receivers tuning on to the channel after a delay or a time in which they did not receive the broadcast transmission will be notified relatively promptly about the delay. Optionally, the notification of the delay is transmitted on the average at least once a minute, 5 times a minute or even 30 times a minute during the entire delay.

In some embodiments of the invention, the network data rate is calculated by averaging the data rates of a plurality of mobile stations in the network, possibly taking into account the overhead for establishing new connections. Alternatively, any other method known in the art may be used to calculate the average data rate or any other measure may be used to represent the network conditions.

### Predetermined Gaps

In the above description, transmission delays are determined responsive to identification of adverse conditions, and if the conditions are of sufficient quality, the entire file is transmitted block after block, without an intervening gap of a delay period. In some embodiments of the invention, however, transmission gaps are inserted at predetermined times, during the transmission, in order to reduce the effect of periods of adverse conditions. These embodiments are especially useful for broadcast transmissions, in which the data is transmitted with redundancy. By stretching the transmission over a larger period, due to the added gaps, receivers that have short periods in which they are busy with other tasks or have bad reception, will generally still be able to receive sufficient data to reconstruct the file, using the redundancy included in the transmitted file.

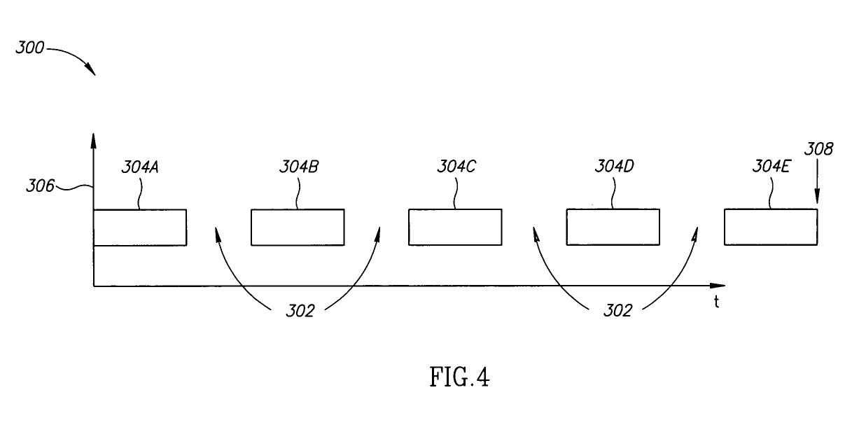

FIG. 4 is a schematic block diagram of a transmission 300 with predetermined gaps 302, in accordance with an exemplary embodiment of the invention. In some embodiments of the invention, the intervening gaps divide the transmission into at least five, eight or even at least ten transmission sessions 304 (marked 304A, 304B, . . . ). Each receiver optionally must receive data in a plurality of the sessions, possibly in at least 30%, 50% or even at least 75% of the sessions, in order to reconstruct the file. The gaps are optionally of at least 1 minute, at least 5 minutes or even at least 10 minutes. In some embodiments of the invention, the gaps occupy at least 10%, at least 20% or even at least 35% of the total transmission time from a beginning point 306 to the end point 308 of the last session 304. Alternatively or additionally, the gaps occupy less than 40%, less than 20% or even less than 10% of the total transmission time of the transmission 300.

In some embodiments of the invention, gaps 302 all have the same length. Alternatively, different gaps 302 have different lengths. Sessions 304 may all have the same length, or may have different lengths.

Possibly, the same transmission parameters are used in all the transmission sessions 304. Alternatively, different sessions 304 use different transmission parameters. In an exemplary embodiment of the invention, different sessions have different forward error correction (FEC) protection ratios. Optionally, later sessions have a higher forward error correction protection ratio, in order to ensure the transmission is successful in view of the remaining transmission time. In some embodiments of the invention, the FEC protection ratio is adjusted dynamically according to feedback received during the transmission 300. For example, the FEC protection ratio of later sessions (e.g., 304D, 304E) may be adjusted responsive to a percentage of receivers that acknowledged reception of the entire broadcast file. Optionally, a threshold is set for the percentage of receivers acknowledging reception of the broadcast file after each of the sessions 304. If the percentage of acknowledging receivers for a specific file is greater than the threshold, a lower FEC protection ratio is optionally used for subsequent sessions. If, however, the percentage of acknowledging receivers for a specific file is lower than the threshold, a higher FEC protection ratio is optionally used for subsequent sessions. Thus, the redundancy used is linked to the network conditions and bandwidth is not wasted on unnecessary redundancy.

It is noted that the predetermined intervening gaps may be used with or without the possibility of adding gaps responsive to adverse conditions.

It will be appreciated that the above described methods may be varied in many ways, including, changing the order of steps, and the exact implementation used. For example, although the transmitted data blocks are mentioned as being parts of transmitted files, they may also be parts of continuous data streams. The methods of the present invention may be performed in various protocol layers and may be performed for a single transmission system in a plurality of communication protocol layers. It should also be appreciated that the above described methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. For example, the principals of the present invention are not limited to cellular networks and may be applied in other environments with substantially any wireless terminals, such as wireless IP networks, wireless broadcast networks or other wireless networks and noisy wireline (e.g., cable) networks. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A wireless receiver device, comprising:
a wireless network interface; and
a processor configured to manage reception of data files through the network interface, to determine network or wireless receiver device conditions and to delay reception of blocks of a file, responsive to the determined conditions meeting specific requirements, although the determined conditions allow reception of a block without the delay.

2. A receiver according to claim 1, wherein the processor is configured to delay reception of further blocks of the file responsive to a determination that the network conditions or device conditions are adverse.

3. A receiver according to claim 2, wherein the processor is configured to delay reception for at least 10 seconds, responsive to the adverse network or device conditions.

4. A receiver according to claim 2, wherein the processor is configured to delay reception for at least a minute, responsive to the adverse network or device conditions.

5. A receiver according to claim 2, further comprising a battery which powers the processor and wherein the processor is configured to delay reception responsive to a determination that a battery charge status of the battery is low.

6. A receiver according to claim 5, wherein the processor is configured to delay reception until after the battery is recharged.

7. A receiver according to claim 5, wherein the processor is configured to delay reception responsive to a determination that the battery charge status is below a threshold, which threshold is above 10%.

8. A receiver according to claim 2, wherein the processor is configured to determine a data rate of recently received data and to time further receptions responsive to the determined data rate.

9. A receiver according to claim 8, wherein the processor is configured to determine the data rate responsive to the time required to receive a previously received block.

10. A receiver according to claim 9, wherein the processor is configured to determine the data rate responsive to the time required to receive a previously received block of the file currently being received.

11. A receiver according to claim 8, wherein the processor is configured to control the timing of reception of blocks by controlling the transmission of requests for further blocks.

12. A receiver according to claim 11, wherein the processor is configured to request the blocks from the server, stating a desired block size and wherein the processor is adapted to request smaller blocks after a reception delay than not after a reception delay.

13. A receiver according to claim 8, wherein the processor is configured to control the timing of reception of blocks by stopping to tune onto a transmission channel to which the receiver was tuned to receive previous portions of the file, which channel continues to carry portions of the data file.

14. A receiver according to claim 1, wherein the processor is configured to delay reception of blocks of a file, even after a first block of the data file was received.

15. A method of receiving data, comprising:
receiving an instruction to receive a data file, by a wireless terminal;
determining a device state of the wireless terminal or a network quality parameter of transmissions to the wireless terminal; and
receiving, by the wireless terminal, one or more blocks of the data file at times determined by the wireless terminal responsive to the determining of the device state or network quality parameter, at least one of the determined times being later than allowable by the determined device state or network quality parameter.

16. A method according to claim 15, wherein receiving blocks at times determined responsive to the determining comprises transmitting requests for blocks of the file at times determined responsive to the determining.

17. A method according to claim 15, wherein receiving blocks at times determined responsive to the determining comprises tuning at the determined times onto a channel carrying data irrespective of acts of the receiver.

18. A method according to claim 15, wherein receiving the instruction comprises receiving a notification that the data file is available for download from a server.

19. A method according to claim 15, wherein determining a network quality parameter comprises determining a data rate of reception of one or more previously transmitted blocks of the file.

20. A method according to claim 15, wherein receiving blocks at times determined responsive to the determining comprises defining a gap of at least 10 seconds during the reception of the file, during which gap the wireless terminal does not receive the file.

21. A method according to claim 15, wherein determining a device state of the wireless terminal or a network quality parameter comprises determining a battery charge level of the wireless terminal.

22. A method according to claim 15, wherein determining a device state of the wireless terminal or a network quality parameter comprises determining whether the battery is currently being recharged.
